(19) United States
(12) Patent Application Publication
(10) Pub. No.: US 2016/0034934 A1
(43) Pub. Date: Feb. 4, 2016

(54) System and Method for a Vendor to Create a Virtual Sales Force That Rewards a Salesperson at Two Distinct Points

(71) Applicant: LUDVICK IBANEZ, Miami, FL (US)

(72) Inventor: LUDVICK IBANEZ, Miami, FL (US)

(21) Appl. No.: 14/447,605

(22) Filed: Jul. 30, 2014

(51) Int. Cl. G06Q 30/02; G06Q 50/00

(52) U.S. Cl. CPC G06Q 30/0214; G06Q 50/01; G06Q 30/0279

(57) ABSTRACT

A system and method for creating a virtual sales force that rewards a salesperson at two distinct points. A vendor develops a virtual sales force by providing a first value and a second value to the salesperson and at least one consumer. The vendor can then win new consumers and repetitive business therefrom without expending heavily on more traditional marketing efforts. The salesperson purchases products from the vendor and provides contact information and network information about potential consumers to receive the values from the vendor. The vendor shares the information on the network, based on the provided network and contact information. The consumer records the values from the network and purchases products or services from the vendor to receive the values. The software application generates revenue by licensing registration information provided by the salesperson to the vendor. In this manner, each party is incentivized.

### BACKGROUND

It is known that the emergence of communication networks such as the Internet and major cellular networks has precipitated interaction between users and other network entities. One such network entity that provides social interaction around common subjects is the social media network. Social media network theory focuses on the relationships and links between individuals or groups of individuals. These social networks can be used for, not only virtual social gatherings, but commercial gain.

The inventor recognized a need to create a virtual sales force at a cost effective rate that also created jobs and value to consumers. The inventor decided to integrate this need with the social media network. The inventor was also aware of the need to create marketing opportunities for vendors that were not expensive and that also incentivized consumers to provide contact information for providing additional potential consumers. The inventor noticed that rewards, such as discounts, coupons, and monetary funds served as a great incentive for consumers. A vendor, who had the products or services for sale, could provide these rewards with little financial loss if transactions occurred at a heavy volume and new consumers were conducting transactions.

The inventor quickly recognized that commercial transactions were commonly conducted using e-commerce systems on the Internet. In a typical e-commerce transaction, a user can access a product/service vendor's website in order to purchase a product or service that the user is interested in. By combining values with e-commerce, the vendor could record information about the consumers and deliver the values more readily.

Through past experiences, the inventor knew that social media sites have proliferated through the Internet. These sites allow a user to connect with “friends” or contacts. The users associated with these social network sites can also broadcast messages from their social networks instantaneously. For the most part, these messages include personal communications. Typically, the proliferation of social network sites presents an opportunity for merchants to market their products or services using the social media sites.

The inventor recognized that registering a number of salespeople to post the products or services on the social media site would be effective because social media networks focus on the relationships and links between individuals or groups of individuals. The salespeople would have built a relationship with potential consumers on the social media site, and thus trust for the product or service would be already present.

However, the inventor also recognized a need to generate further revenue for the salespeople. The inventor was aware that sales positions that rewarded marketing efforts were a possible source of employment for many people, who may generally be unemployable at regular office hour jobs. The salespeople were thus given a reward for not only purchasing a product from the vendor, but also providing the information for the social media site. This in essence, created a form of employment.

The inventor also knew that most people were lazy and would not make a heavy effort to receive rewards. The inventor decided to facilitate the recording of messages and rewards on the social media site by putting them in the form of a QR code, which could be scanned, downloaded, or captured by a camera.

The inventor also recognized the need to provide values to consumers. The inventor decided to enable the consumers to receive rewards by recording the rewards from the social media site, and purchasing a product or service form the vendor. The inventor further enhanced the salespeople's job by providing a second reward to the salespeople when the consumer made a transaction with the reward.

Vendor supplied values have been used for incentivizing sales have been used in the past, yet none with the present characteristics of the present invention. See Patent numbers: U.S. 20120303435; U.S. 20130006736; and U.S. 20090070228.

For the foregoing reasons, there is a need for a system and method for creating a virtual salesforce through a social media network that creates a mutually beneficial synergy between a vendor, a salesperson, and a consumer.

### SUMMARY

The present invention is directed to a method and system for a vendor to create a virtual sales force that rewards a salesperson at two distinct points. The system and method provides a software application that generates various incentives and residual benefits for a vendor, a salesperson, and at least one consumer. The software application creates a synergy between the parties through electronic exchange of values, moneys, and social media marketing in a common network, such as a social media site.

In one embodiment, the vendor develops a virtual sales force by providing a first value and a second value to the salesperson and the consumer. The vendor can then win new consumers and repetitive business therefrom without expending heavily on more traditional marketing efforts. The salesperson purchases products from the vendor and provides contact information and network information about potential consumers to receive the values from the vendor. The vendor shares the information on the network, based on the provided network and contact information. The consumer records the values from the network and purchases products or services from the vendor to receive the values. The software application generates revenue by licensing registration information provided by the salesperson to the vendor. In this manner, each party is incentivized.

In this manner, the vendor may create a virtual sales force with minimal marketing and labor costs, while still receiving exposure to large numbers of consumers that may not have been reached otherwise. The salesperson is incentivized to provide contact information for social media and other personal and business contacts to receive two distinct values—a first value during purchase of the product or service, and a second value when the consumer purchases the product or service. The consumer receives easily accessible values through social media sites or other shared communications with the salesperson. The system and methods is made more efficient through the use of electronic identifiers that can have information easily adjusted by the vendor and the software application to reflect personal information and values. The identifiers can also be presented in a digital format for viewing, recording, and conversion during transactions.

In one embodiment of the present invention, a method comprises an initial Step of providing a software application. The software application operates the method by storing personal and contact information, identifiers, and values. The software application may also distribute the data accordingly to the appropriate party throughout the method. The software application may be accessed by the vendor, the salesperson, or the consumer from different platforms.

The method may include a further Step of registering, by a salesperson, to receive the software application, by providing personal information, network information, and potential consumer contact information. This information is used by the vendor for marketing purposes. In some embodiments, the registration through the software application requires the salesperson to provide the personal information, network information, and contact information to a personal information database that operatively connect to the software application. The salesperson also provides contact information on potential consumers from social media sites, personal contacts, and business contacts.

A Step comprises providing a unique identifier to the salesperson. The software application may generate the unique identifier, which is unique to the salesperson, based on the provided information during registration. The unique identifier comprises personal information about the salesperson, such as name, duration involved with the software application, contact information, and the like. The unique identifier is assigned, delivered, and displayed in various digital forms, including, without limitation, a QR code, a bar matrix code, a machine readable optical identifier, a password, or an alphanumeric sequence. The software application and the vendor can have access to the unique identifier. The salesperson may download the software application on a communication device, such as a smart phone, a laptop, or a computer system. However in alternative embodiments, the salesperson may receive the unique identifier through postal mail, email, telephone, text, or a portable storage device.

A Step may further include purchasing, by the salesperson, a product or service from a vendor. The vendor conducts the transaction for the product or service with the salesperson through traditional exchange of products or services for a monetary fund, or in some embodiments, bartering for equivalent products or services. In some embodiments, the purchase and correlating transaction information is stored in a transaction database that operatively connect to the software application.

A next Step comprises sharing, by the vendor, a second identifier on a network. The vendor shares the second identifier on the network simultaneously during the transaction with the salesperson. The salesperson and the at least one consumer can view the second identifier upon display on the network. The network may include, without limitation, a social media site, a social networking service, an internet, an intranet, a website, and a publication. The network information and potential consumers who have access to the network are provided by the salesperson during the registration in the initial Step. The second identifier posted on the network comprises the unique identifier, a message, and a second value. The second identifier can be viewed and recorded by at least one consumer on the network. In some embodiments, the second identifier includes a message indicating that the salesperson has transacted a product or service with the vendor. The message indicates to the consumer which salesperson has purchased the product and service from which vendor. The second identifier further comprises a second value for the consumer to access, record, and convert during a transaction with the vendor. The second value may include a discount, coupon, monetary amount, or bonus that is redeemable upon conducting a transaction with the vendor.

In some embodiments, a Step may include awarding, by the vendor, a first value to the salesperson. The vendor awards the salesperson the first value upon sharing the second identifier on the network. This creates a reward of sorts to the salesperson for sharing the network information, and further, enables the vendor to access the potential consumers. The first value can be awarded to the salesperson by depositing the first value into a depository of the salesperson. In some embodiments, the method may include a Step of recording, by the consumer, the second value from the second identifier on the network. The consumer records the second value to use in a transaction with the vendor. The second value may be recorded by capturing a screen image, taking a picture, printing, or downloading. A further Step comprises conducting a transaction, by the consumer, to purchase a product or service from the vendor with the second value. The second value, similar to the first value, may include, without limitation, a discount, coupon, monetary amount, or bonus that is redeemable upon conducting a transaction with the vendor. A final Step includes awarding, by the vendor, a first portion of the second value to the consumer, and a second portion of the second value to the salesperson. The second value can be awarded by depositing the second value into a depository of the salesperson and the consumer, or the second value can be used directly while performing the transaction, such as a coupon.

One objective of the present invention is to enable a vendor to create a virtual sales force that rewards a salesperson with values at two distinct points in the method.

Another objective is for the salesperson to receive the first value for providing access to the network of potential consumers, and the second value for indirectly providing a consumer who conducts transactions with the vendor.

Another objective is for the consumer to receive the second value for conducting a transaction with the vendor.

Another objective is for the vendor to receive new markets and consumers with minimal marketing costs.

Yet another objective is to enable purchases for products or services

Yet another objective is to deposit the values to an electronic depository, such as an electronic wallet in a smart phone.

Yet another objective is to have a plurality of salespeople providing networks and contact information about potential consumers to the vendor.

Yet another objective is to enable a plurality of vendors to receive licenses for the software application.

Yet another objective is to stimulate the economy by generating jobs in the form of the salesperson.

### DRAWINGS

These and other features, aspects, and advantages of the present invention will become better understood with regard to the following description, appended claims, and drawings where:

FIGS. 1A and 1B are flowchart diagrams for a vendor to create a virtual sales force that rewards a salesperson at two distinct points;

FIG. 2 is a flowchart diagram of a method for a vendor to create a virtual sales force that rewards a salesperson at two distinct points; and

FIG. 3 is a block diagram depicting an exemplary client/server system which may be used by an exemplary web-enabled/networked embodiment of the present invention.

### DESCRIPTION

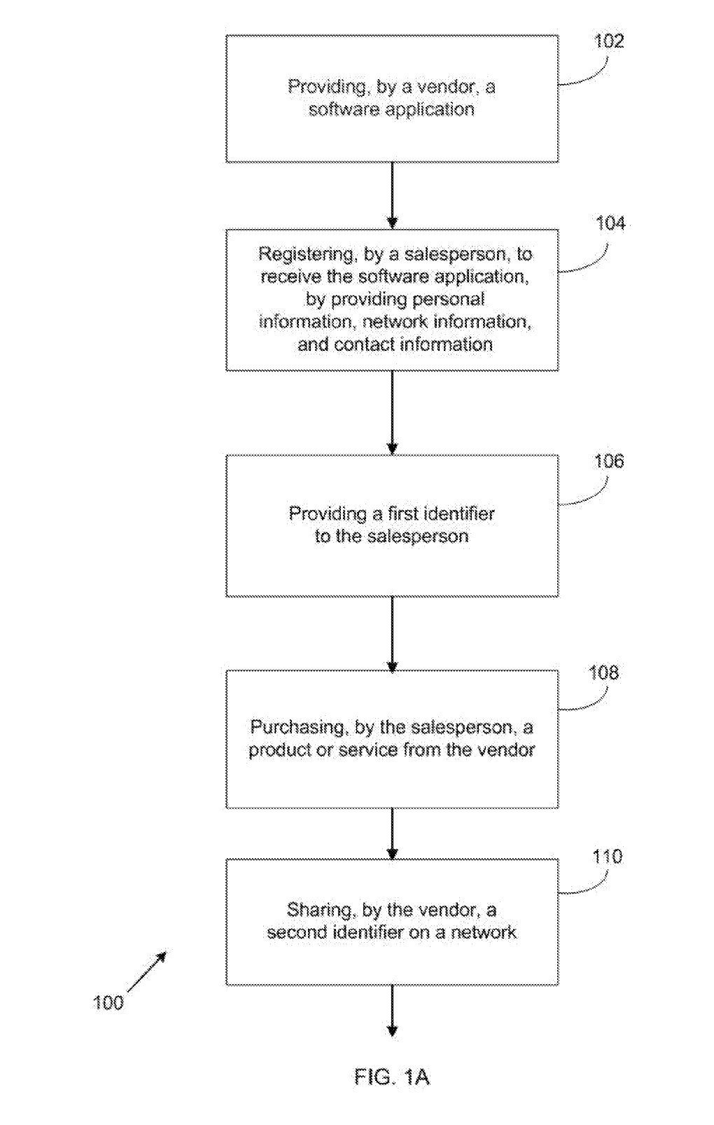

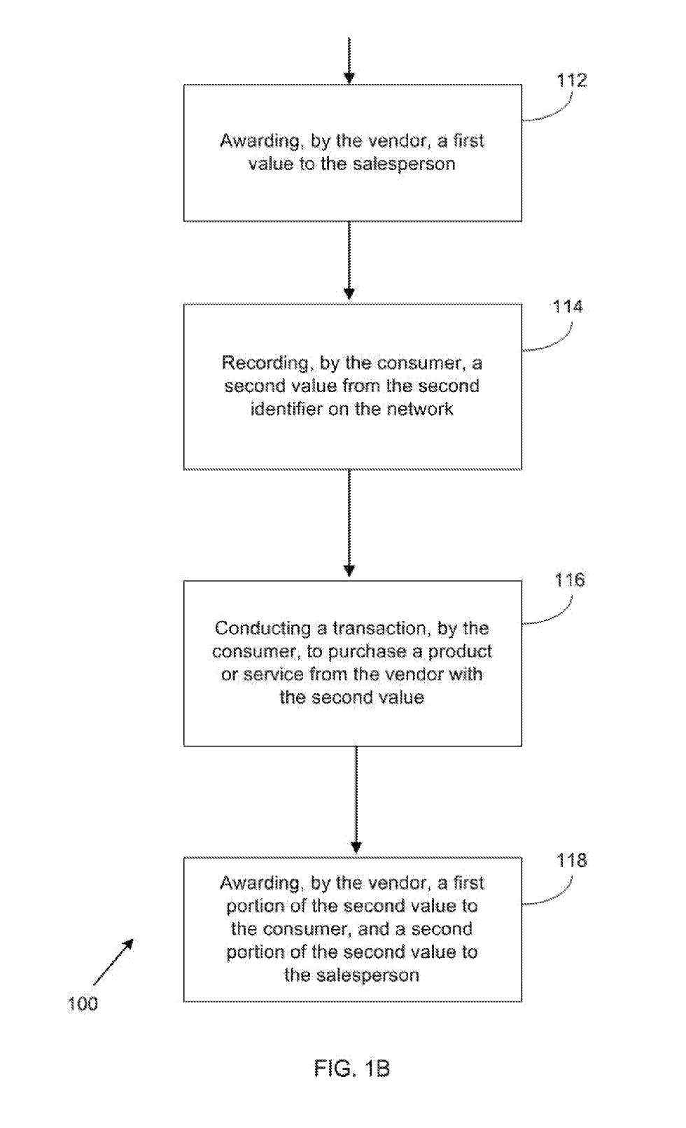

One embodiment, referenced in FIGS. 1A-3, illustrates a method 100 and system 200 for a vendor to create a virtual sales force that rewards a salesperson at two distinct points. In one embodiment, the vendor 208 provides a first value 214 and a second value 224 to the salesperson 210 and at least one consumer 218 in order to win new consumers 218 and repetitive business therefrom. The vendor 208 may include, without limitation, a retail store, a grocery store, a chain store, an online store, an offline store, and a wholesaler. The salesperson 210 purchases products from the vendor 208 and provides contact information of networks 220 and potential consumers 218 to the vendor 208 to receive the values 214, 224. The salesperson 210 may include a person, organization, or system 200 that wishes to receive values for making purchases from the vendor 208, while also receiving residual income from sharing personal information and network information. The at least one consumer 218 records the second value 224 from the network 220 and purchases products or services from the vendor 208 to receive the values 214, 224. The consumer 218 may include a person, organization, or system 200 who wishes to record the values 214, 224 from the network 220, and subsequently uses the values 214, 224 to purchase products or services from the vendor 208. The software application 202 generates revenue by licensing registration information provided by the salesperson 210 to the vendor 208.

The method 100 and system 200 provides numerous advantages for marketing products and services by enabling the vendor 208 to create a virtual sales force with minimal marketing and labor costs, while still receiving exposure to large numbers of consumers 218 that may not have been reached otherwise. The salesperson 210 is incentivized to provide contact information for social media and other personal and business contacts to receive two distinct values 214, 224—a first value 214 during purchase of the product or service, and a second value 224 when the consumer 218 purchases the product or service.

The consumer 218 also receives advantages by obtaining easily accessible values 214, 224 through the network 220, such as social media sites or other shared communications with the salesperson 210. The method 100 and system 200 is made more efficient through the use of electronic identifiers 212, 222 that can have information easily adjusted by the vendor 208 and the software application 202 to reflect personal information, network 220 information, messages 226, and values 214, 224. The identifiers 212, 222 can also be presented in a digital format for viewing, recording, and conversion during transactions.

As referenced in FIGS. 1A and 1B, a method 100 comprises an initial Step 102 of providing a software application 202 for operation and control functions. The software application 202 operates the method 100 by storing personal and contact information, identifiers 212, 222, and values 214, 224. The software application 202 may also distribute the data accordingly to the appropriate party throughout the method 100. The software application 202 may be accessed by the vendor 208, the salesperson 210, or the consumer 218 from different platforms. In one embodiment, the software application 202 is downloadable on a smart phone. However, the software application 202 may be accessed through other virtual means, including, without limitation, portable storage devices, cd's, tapes, and copying.

The method 100 may include a further Step 104 of registering, by a salesperson 210, to receive the software application 202. The salesperson 210 receives the software application 202 by providing personal information, network information, and potential consumer contact information. This information is used by the vendor 208 for marketing purposes. In some embodiments, the registration through the software application 202 requires the salesperson 210 to provide the personal information, network information, and contact information to a personal information database 204 that operatively connect to the software application 202. The salesperson 210 also provides contact information on potential consumers 218 that share a network 220, social media sites, personal contacts, or business contacts with the salesperson 210.

A Step 106 comprises providing a unique identifier 212 to the salesperson 210. The software application 202 may generate the unique identifier 212, which is unique to the salesperson 210, based on the provided information during registration. In some embodiments, the unique identifier 212 may include personal information about the salesperson 210, such as name, duration involved with the software application 202, contact information, and the like. The unique identifier 212 is assigned, delivered, and displayed in various digital forms, including, without limitation, a QR code, a bar matrix code, a machine readable optical identifier, a password, or an alphanumeric sequence. The software application 202 and the vendor 208 can have access to the unique identifier 212. The salesperson 210 may download the software application 202 on a communication device, such as a smart phone, a laptop, or a computer system 200. However in alternative embodiments, the salesperson 210 may receive the unique identifier 212 through postal mail, email, telephone, text, or a portable storage device.

A Step 108 may further include purchasing, by the salesperson 210, a product or service from the vendor 208. The vendor 208 conducts the transaction for the product or service with the salesperson 210 through traditional exchange of products or services for a monetary fund 216, or in some embodiments, bartering for equivalent products or services. In some embodiments, the purchase and correlating transaction information is stored in a transaction database 206 that operatively connect to the software application 202.

A next Step 110 comprises sharing, by the vendor 208, a second identifier 222 on a network 220. The vendor 208 shares the second identifier 222 on the network simultaneously during the transaction with the salesperson 210. The salesperson 210 and the at least one consumer 218 can view the second identifier 222 upon display on the network 220. The network 220 may include, without limitation, a social media site, a social networking service, an internet, an intranet, a website, and a publication. Those skilled in the art will recognize that social media networks focus on the relationships and links between individuals or groups of individuals. The salesperson 210 has built a relationship with potential consumers 218 on the social media site, and thus trust for the product or service is present. The network information and potential consumers 218 who have access to the network 220 are provided by the salesperson 210 during the registration in the initial Step 102. The second identifier 222 posted on the network 220 comprises the unique identifier 212, a message 226, and a second value 224. Similar to the unique identifier 212, the second identifier 222 may include without limitation, a QR code, a bar matrix code, a machine readable optical identifier, a password, or an alphanumeric sequence. The second identifier 222 can be viewed and recorded by at least one consumer 218 on the network 220.

In some embodiments, the second identifier 222 includes a message 226 indicating that the salesperson 210 has transacted a product or service with the vendor 208. For example, “Hello, Did you know that Bob has purchased a shovel from Joe's hardware store?”. The message 226 indicates to the consumer 218 which salesperson 210 has purchased the product and service from which vendor 208. In one alternative embodiment, the message 226 can also include reviews for the product or service. The second identifier 222 further comprises a second value 224 for the consumer 218 to access, record, and convert during a transaction with the vendor 208. The second value 224 may include a discount, coupon, monetary amount, or bonus that is redeemable upon conducting a transaction with the vendor 208.

In some embodiments, a Step 112 may include awarding, by the vendor 208, a first value 214 to the salesperson 210. The vendor 208 awards the salesperson 210 the first value 214 upon sharing the second identifier 222 on the network 220. This creates a reward of sorts to the salesperson 210 for sharing the network information, and further, enables the vendor 208 to access the potential consumers 218. The first value 214 can be awarded to the salesperson 210 by depositing the first value 214 into a depository of the salesperson 210.

In some embodiments, the method 100 may include a Step 114 of recording, by the consumer 218, the second value 224 from the network 220. The consumer 218 records the second value 224 to use in a transaction with the vendor 208. The second value 224 may be recorded by capturing a screen image, taking a picture, printing, or downloading. It is significant to note that the consumer 218 is not searching, or shopping for the product or service. Rather, the consumer 218 receives the second identifier 222 through the network 220, such as a social media site. A further Step 116 comprises conducting a transaction, by the consumer 218, to purchase a product or service from the vendor 208 with the second value 224. The second value 224, similar to the first value 214, may include, without limitation, a discount, coupon, monetary amount, or bonus that is redeemable upon conducting a transaction with the vendor 208. A final Step 118 includes awarding, by the vendor 208, a first portion of the second value 224 to the consumer 218, and a second portion of the second value 224 to the salesperson 210. The second value 224 can be awarded by depositing the second value 224 into a depository of the salesperson 210 and the consumer 218, or the second value 224 can be used directly while performing the transaction, such as a coupon. In one alternative embodiment, the salesperson 210 or the consumer 218 may donate at least a portion of the values 214, 224 to a charity.

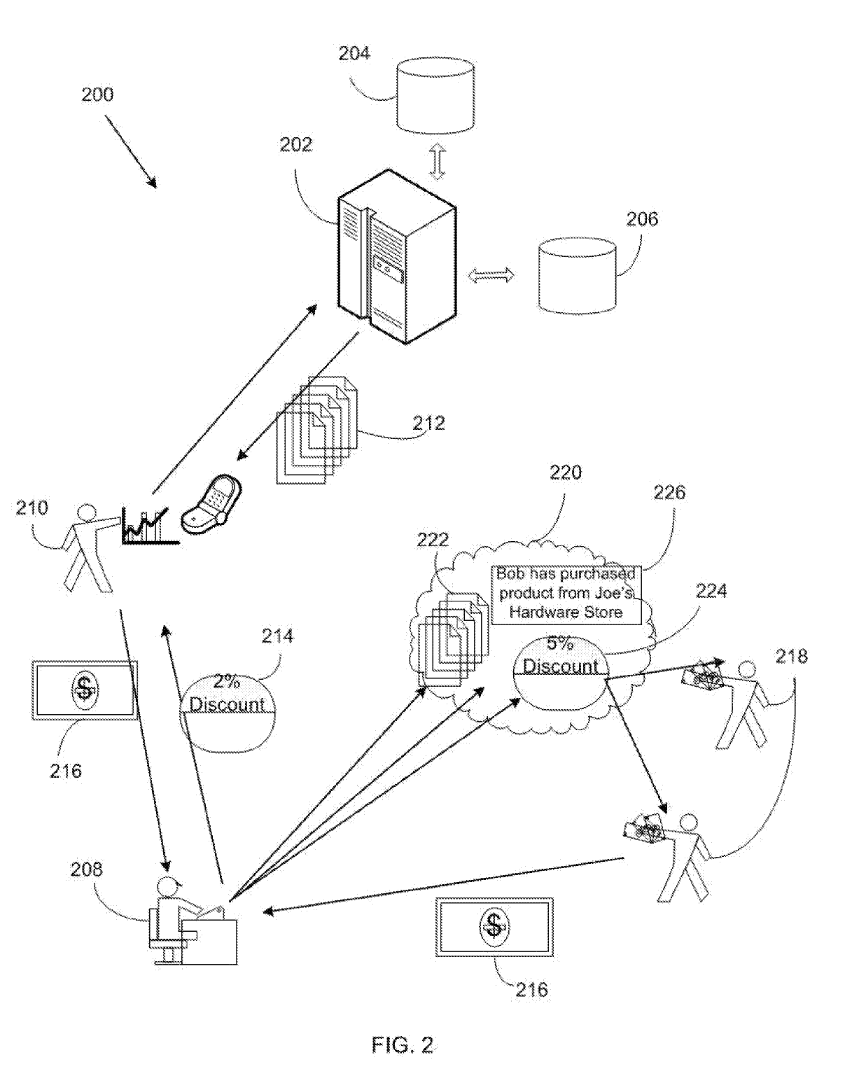

Turning now to FIG. 2, a system 200 for a vendor to create a virtual sales force that rewards a salesperson at two distinct points is illustrated. The system 200 comprises a software application 202 configured to operate a virtual sales force. The software application 202 operates the method 100 by storing personal and contact information, identifiers 212, 222, and values 214, 224. The system 200 further comprises a salesperson 210. The salesperson 210 registers to download the software application 202 by providing personal information, network information, and contact information for potential consumer 218. This information is used by the vendor 208 for marketing purposes. The software application 202 utilizes the information to generate a unique unique identifier 212 for the salesperson 210. The unique identifier 212 may include without limitation, a QR code, a bar matrix code, a machine readable optical identifier, a password, or an alphanumeric sequence. The information that is stored in a unique identifier 212 can include personal information of the salesperson 210, network information of potential consumers 218 on a network 220, and contact information for the salesperson 210 and the potential consumers 218.

The system 200 further comprises a vendor 208 for conducting a first transaction with the salesperson 210 and providing a first value 214 and a second value 224 to the salesperson 210 upon sharing the unique identifier 212, a message 226, and a second value 224 on the network 220. The network 220 may include, without limitation, a social media site, a social network 220ing service, an internet, an intranet, a website, and a publication. The system 200 may also include a consumer 218 for recording a second identifier 222 and the second value 224 from the network 220 and using the second value 224 to conduct a transaction with the vendor 208. The second identifier 222 can be viewed and recorded by at least one consumer 218 on the network 220.

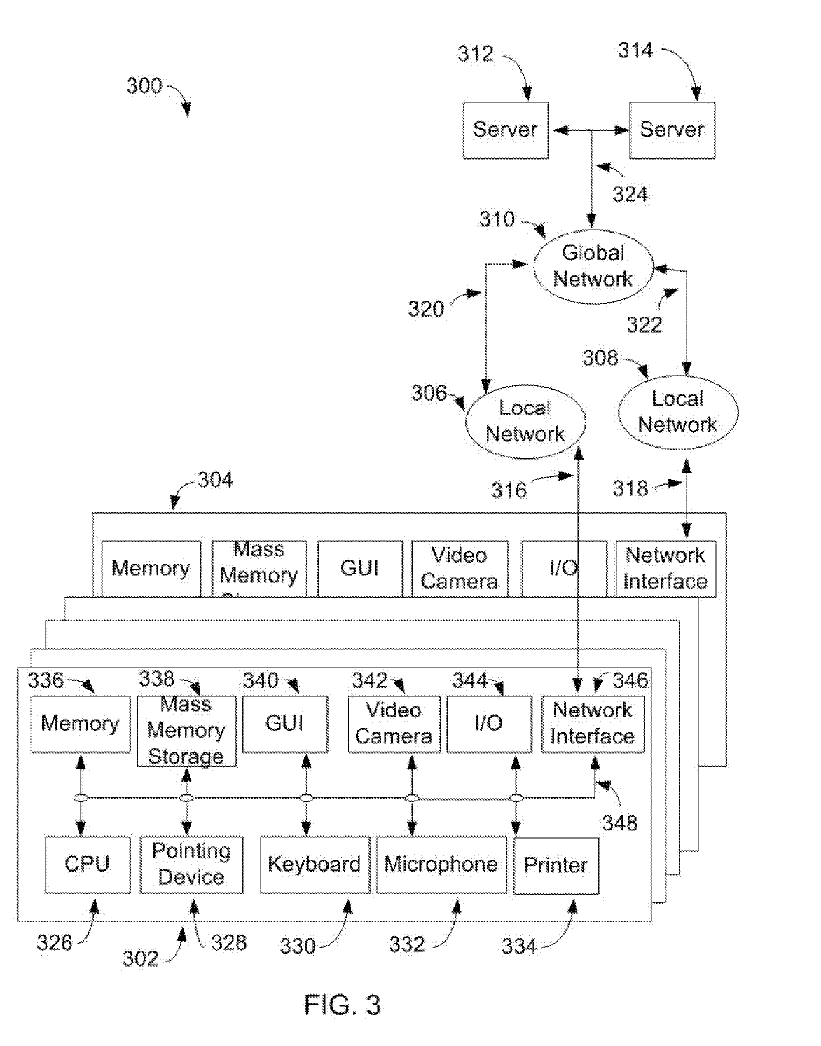

FIG. 3 is a block diagram depicting an exemplary client/server system which may be used by an exemplary web-enabled/networked embodiment of the present invention.

A communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. For example, the system could be used between a supplier and a wholesale purchaser to incentivize large purchases by providing values through a wholesale networking site. Accordingly, the scope should be determined not by the embodiments illustrated, but by the appended claims and their legal equivalents.

What is claimed is:

1. One or more computer storage media storing computer-usable instructions, that when used by one or more computing devices, cause the one or more computing devices to perform a method for a vendor to create a virtual sales force that rewards a salesperson at two distinct points, the method comprising:
providing, by a vendor, a software application;
registering, by a salesperson, to receive the software application, by providing personal information, network information, and potential consumer contact information;
providing a unique identifier to the salesperson;
purchasing, by the salesperson, a product or service from the vendor;
sharing, by the vendor, a second identifier on a network;
awarding, by the vendor, a first value to the salesperson;
recording, by at least one consumer, a second value from the second identifier on the network;
conducting a transaction, by the at least one consumer, to purchase a product or service from the vendor with the second value; and
awarding, by the vendor, a first portion of the second value to the at least one consumer, and a second portion of the second value to the salesperson.

2. The method of claim 1, wherein the software application operates the method.

3. The method of claim 1, wherein the software application includes a personal database, a products and services database, and a purchases database.

4. The method of claim 1, wherein the salesperson downloads the software application onto a smart phone.

5. The method of claim 1, wherein the unique identifier includes salesperson name, duration that salesperson is involved with the software application, and salesperson contact information.

6. The method of claim 1, wherein the at least one consumer records the second value by capturing a screen image.

7. The method of claim 1, wherein the network is a social media site is shared by the salesperson and the at least one consumer.

8. The method of claim 1, wherein the second identifier includes the unique identifier, a message, and the second value.

9. The method of claim 1, wherein the first and second values include a coupon, a discount, a monetary amount, and a bonus.

10. The method of claim 1, further including a step of donating, by the salesperson or the at least one consumer, at least a portion of the first or second values to a charity organization.

11. A non-transitory program storage device readable by a machine tangibly embodying a program of instructions executable by the machine to perform a method for a vendor to create a virtual sales force that rewards a salesperson at two distinct points, the storage device comprises:
(a) computer code for providing, by a vendor, a software application;
(b) computer code for registering, by a salesperson, to receive the software application, by providing personal information, network information, and potential consumer contact information;
(c) computer code for providing a unique identifier to the salesperson, the unique identifier having personal information, financial information, and contact information about the salesperson;
(d) computer code for purchasing, by the salesperson, a product or service from the vendor;
(e) computer code for sharing, by the vendor, a second identifier on a network, the second identifier having the unique identifier, a message, and a second value, the network having a social media site;
(f) computer code for awarding, by the vendor, a first value to the salesperson, the first value having a discount for a product or service;
(g) computer code for recording, by at least one consumer, a second value from the second identifier on the network;
(h) computer code for conducting a transaction, by the at least one consumer, to purchase a product or service from the vendor with the second value; and
(i) computer code for awarding, by the vendor, a first portion of the second value to the at least one consumer, and a second portion of the second value to the salesperson.

12. The storage device of claim 11, further including computer code for donating, by the salesperson or the at least one consumer, at least a portion of the first or second values to a charity organization.

13. A system for a vendor to create a virtual sales force that rewards a salesperson at two distinct points, the system comprises:
a software application configured to operate a virtual salesforce;
a salesperson for providing information to the software application, the information having a personal information of the salesperson, a network information of potential consumers on a network, and a contact information for the salesperson and the potential consumers;
a vendor for conducting a first transaction with the salesperson and providing a first value and a second value to the salesperson upon sharing a unique identifier, a message, and a second value on the network;
at least one consumer for recording a second identifier and the second value from the network and using the second value to conduct a transaction with the vendor.

14. The system of claim 13, wherein the network is a social media site is shared by the salesperson and the at least one consumer.

15. The system of claim 13, wherein the second identifier includes the unique identifier, a message, and the second value.

16. The system of claim 13, further including the salesperson or the at least one consumer donating at least a portion of the first or second values to a charity organization.
